(19) United States
(12) Patent Application Publication
(10) Pub. No.: US 2008/0075064 A1
(43) Pub. Date: Mar. 27, 2008

(54) Device to PC authentication for real time communications

(75) Inventors: Anton W. Krantz, Kirkland, WA (US); Dawson Yee, Bellevue, WA (US); Niraj K. Khanchandani, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/514,020

(22) Filed: Aug. 30, 2006

(51) Int. Cl. H04L 12/66

(52) U.S. Cl. 370/352

(57) ABSTRACT

A method for securely pairing an IP phone with a computing device during VoIP communication on an IP network comprising a plurality of IP phones and computing devices is disclosed. The method pairs an IP phone with a computing device. The IP phone is authenticated to the computing device and the computing device to the IP phone using an identity registered with an identity service. If the authentication succeeds, a pairing data structure is created on the IP phone that is dedicated to communicating with the computing device and a pairing data structure on the computing device is created that is dedicated to communicating with the IP phone.

### BACKGROUND

In traditional telephony, a telephonic device, i.e., an analog telephone (“phone”), converts sound waves into an analog electrical signal that is transmitted over a channel to another phone which converts the analog electrical signal into sound waves. Later developed digital phones digitize the analog signals, packetize the resulting digital signals, which are transmitted to a receiving phone where the packets are combined and converted into analog signals and then, sound waves. Using a technique known as Voice Over Internet Protocol (VoIP), computing devices have been used to digitize the analog voice signals, break the digitized signals into frames, place the frames into packets, and transmit the packets over the Internet to another computing device. The receiving computing device extracts the frames from the packets, assembles the frames into a digitized signal, and converts the digitized signal into an analog voice signal.

In both the traditional and VoIP techniques, the phone acts as an audio device that converts sound waves into an analog electrical signal and vice versa. In traditional telephony, the phone also functions as the transmitter and receiver. It is also possible to pair a computing device with a phone. In such a pairing, the computing device functions as the transmitter and receiver and the phone provides the audio input and output. The paired devices provide telephony service.

When using VoIP, it is desirable that the pairing of a computing device with a phone is accomplished in a secure fashion with a minimum of user or administrative intervention.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Pairing a phone with a computing device for secure VoIP communication on an IP network is disclosed. The phone may be a single phone or selectable from a plurality of phones. The computing device may be a single computing device or selectable from a plurality of computing devices. The phone is authenticated to the computing device and the computing device is authenticated to the phone using an identity provided by an identity service such as an SIP service. If the authentications succeed, a pairing data structure, dedicated to communicating with the computing device, is created on the phone and a pairing data structure, dedicated to communicating with the phone, is created on the computing device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of an exemplary network suitable for pairing computing devices with phones;

FIG. 2 is a diagram of an exemplary device pairing using a USB channel for authentication;

FIG. 3 is a diagram of an exemplary device pairing using an IP channel for authentication;

FIG. 4 is a diagram of an exemplary device pairing involving multiple computing devices and using an IP channel for authentication;

FIG. 5 is a flow diagram of an exemplary method for pairing an IP phone with a computing device using an IP channel for authentication;

FIG. 6 is a flow diagram of an exemplary method for pairing a computing device with an IP phone using an IP channel for authentication;

FIG. 7 is a flow diagram of an exemplary method for pairing an IP phone with a computing device using a USB channel for authentication; and

FIG. 8 is a flow diagram of an exemplary method for pairing a computing device with an IP phone using a USB channel for authentication.

### DETAILED DESCRIPTION

In VoIP communication, a computing device is often paired with a phone to provide telephony service. During the pairing of a computing device and a phone, it is desirable that the computer and the phone be securely authenticated. It is preferable that secure authentication is accomplished with little or no direct human intervention such as manual configuration by users or network administrators. One component used to enable such secure authentication is an identity service capable of providing identifiers for devices such as phones and computing devices. An example of an identity service that enables secure authentication is a session initiation protocol (SIP) service. Typically an SIP service is provided by an SIP server.

SIP is a protocol for initiating, modifying, and terminating an interactive user session that involves multimedia elements such as video, voice, instant messaging, online games, and virtual reality. SIP is a preferred signaling protocol for VoIP. While primarily used to set up and tear down voice or video calls, SIP may also be used in instant messaging (IM), to publish and subscribe presence information, or in applications where session initiation is required. One purpose of SIP is to provide a signaling and call set-up protocol for IP based communications that can support a superset of the call processing functions and features present in the public switch telephone network (PSTN). While SIP does not define PSTN features, SIP enables the building of such features into network elements such as proxy servers and user agents to provide familiar telephone-like operations such as, but not limited to, dialing a number, causing a phone to ring, and producing ring-back tones or a busy signal. Hence, a network in which computing devices are paired with phones often contains an SIP service provided by an SIP server or by a peer-to-peer network of phones and computing devices each operating an SIP software application.

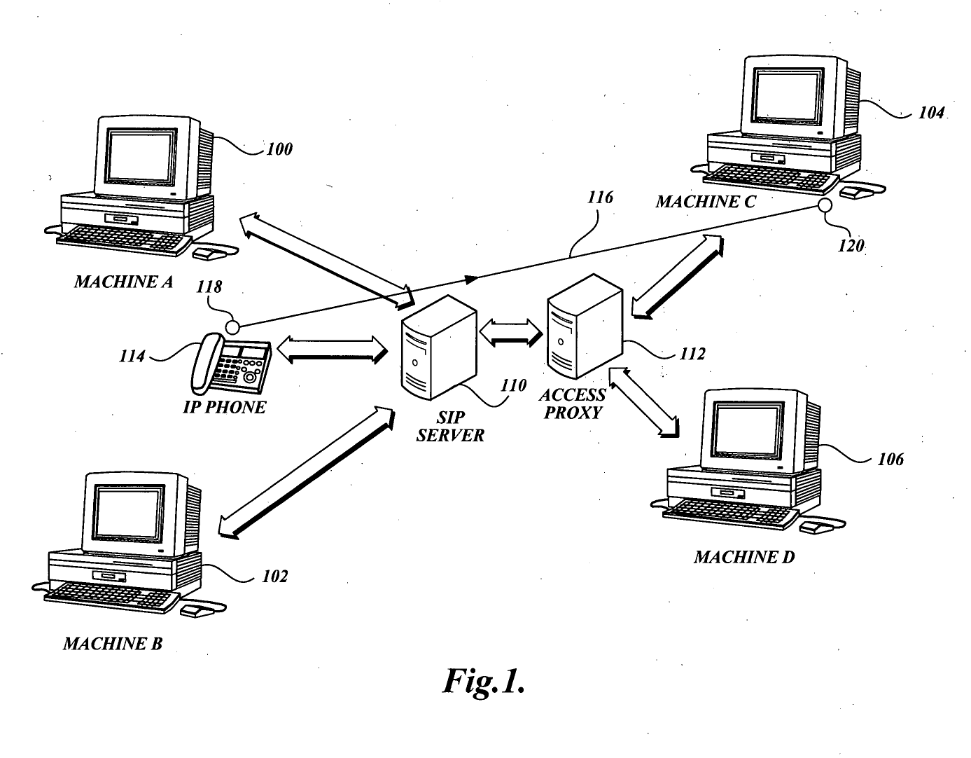

FIG. 1 illustrates a diagram of an exemplary network in which computing devices may be paired with phones. The exemplary network illustrated in FIG. 1 is assembled from various computing and communication devices. In particular, a computing device, machine A 100, communicates with an SIP server 110. A second computing device, machine B 102, and an IP phone 114, also communicate with the SIP server 110. The SIP server 110 communicates with an access proxy 112. The access proxy 112 communicates with a third computing device, machine C 104, and also with a fourth computing device, machine D 106. A pairing 116 provides secure VoIP communication between the IP phone 114 and machine C 104. The pairing 116 is enabled by a pairing data structure component, i.e., a pairing data structure, 118 residing on the IP phone 114 and a pairing data structure 120 residing on the machine C 104.

The pairing 116 may be created using an IP channel or a USB channel for authentication. Preferably, the pairing data structure components, i.e., the pairing data structures, that enable the pairing reside on the computing devices and/or the phones. While the pairing data structures on the computing devices and phones access the SIP server, preferably, the pairing data structures are not a part of the SIP server. When a pairing is created, a pairing data structure, dedicated to communicating with the computing device, is created on the phone and a pairing data structure, dedicated to communicating with the phone, is created on the computing device. The pairing data structures are created by a pair data structuring component. Other software components may be used to enable pairing and/or creating pair data structures. Hence, pairing data structures and pair data structuring components should be construed as exemplary and not limiting.

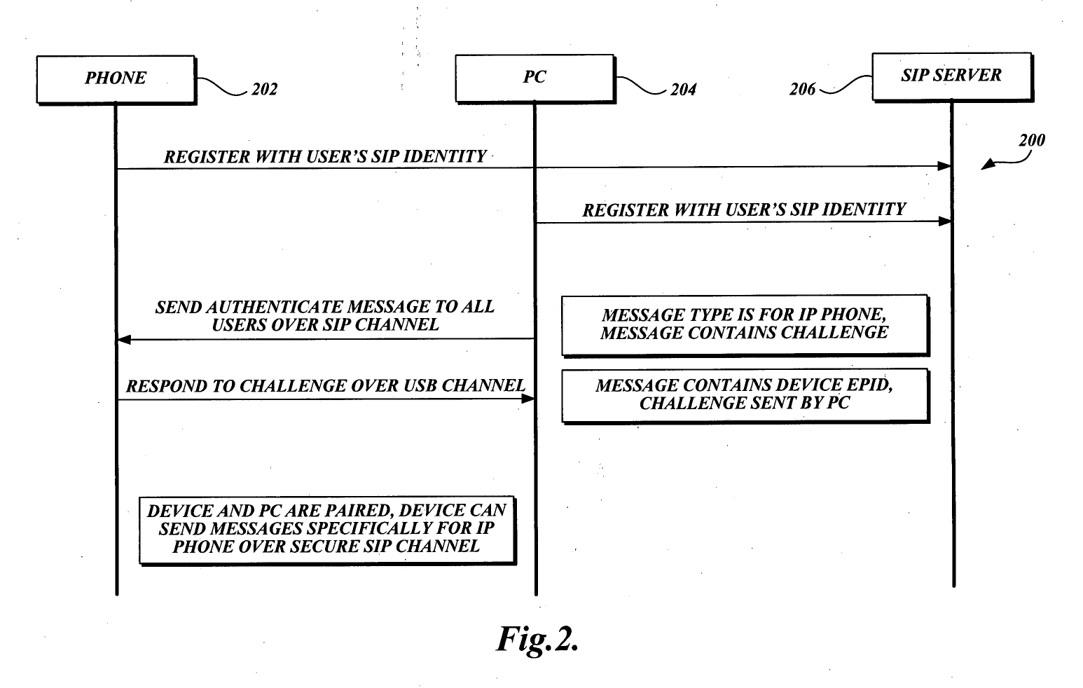

FIG. 2 is an exemplary diagram illustrating an exemplary process of pairing a computing device with a phone using a USB channel for authentication to provide secure VoIP communication on an IP network, such as an Ethernet network. In the exemplary process 200 illustrated in FIG. 2, a phone 202, a computing device, i.e., PC 204, and an SIP server 206 interact. As noted above, preferably, the software components that enable the pairing reside on the PC 204 and the phone 202. The process 200 begins at the top of FIG. 2 where the phone 202 registers with the SIP server 206 using the user's SIP identity. The PC 204 also registers with the SIP server 206 using the user's SIP identity. It is also possible for the PC 204 to register with the SIP server 206 before the phone 202 registers with the SIP server 206. The PC 204 sends an authentication message to all users, i.e., all users connected to the IP network, over the SIP channel. Because the phone 202 is connected to the IP network, the phone 202 receives the authentication message. The authentication message's message type is for an IP phone and the authentication message contains a challenge. The phone 202 responds to the challenge over the USB channel. The authentication message contains a device EPID (end point identifier) and the challenge sent by the PC 204. When the PC 204 receives the phone's response, the PC 204 verifies that the appropriate response has been received from the USB channel. If the PC 204 receives the phone's response on the USB channel, the device, e.g., phone 202, and the PC, e.g., PC 204, are paired and the device can send messages specifically for the IP phone over a secure SIP channel. If the PC 204 receives the phone's response on a channel other than the USB channel, the device and the PC are not paired and the device cannot send messages specifically for the IP phone over a secure SIP channel.

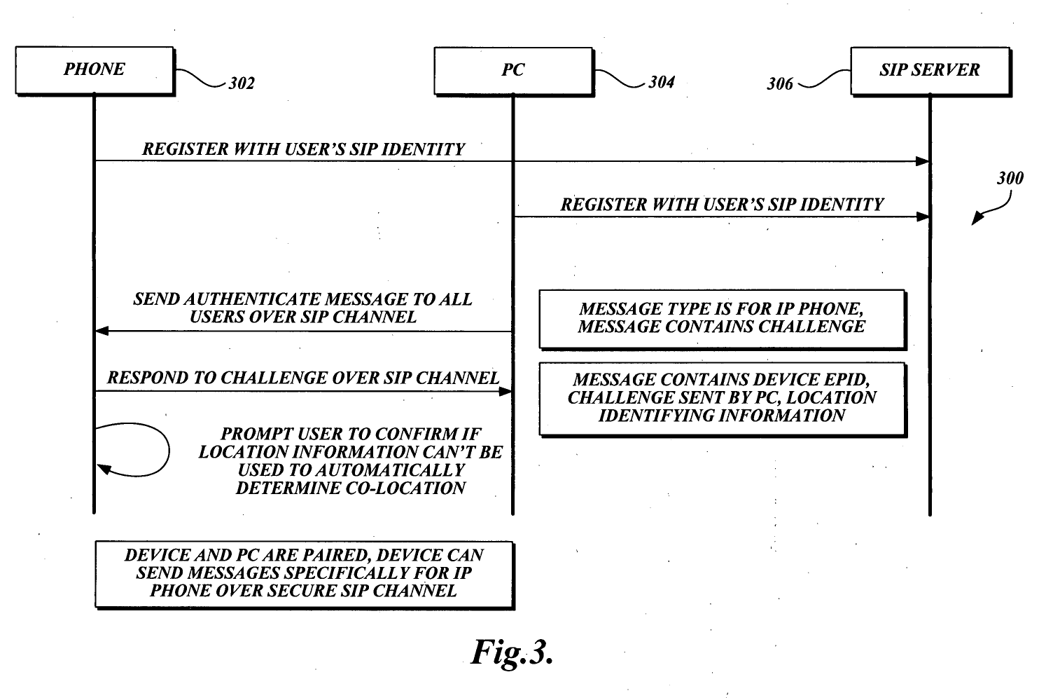

In contrast to FIG. 2, which illustrates an exemplary process of pairing a PC with a phone using more than one channel, i.e., an IP channel and a USB channel, for authentication, FIG. 3 illustrates an exemplary process of pairing a PC with a phone using an IP channel for authentication to provide secure VoIP communication on an IP network. In the exemplary process 300 illustrated in FIG. 3, a phone 302, a computing device, i.e., PC 304, and an SIP server 306 interact. As noted above, preferably, the software components that enable the pairing reside on the PC 304 and the phone 302. The process 300 begins at the top of FIG. 3 where the phone 302 registers with the SIP server 306 using the user's SIP identity. The PC 304 also registers with the SIP server 306 using the user's SIP identity. It is also possible for the PC 304 to register with the SIP server 306 before the phone 302 registers with the SIP server 306. The PC 304 sends an authentication message to all users, i.e., all users connected to the IP network, over the SIP channel. Because the phone 302 is connected to the IP network, the phone 302 receives the authentication message. The authentication message's message type is for an IP phone and the authentication message contains a challenge. Unlike the exemplary process 200 illustrated in FIG. 2, in the exemplary process 300 illustrated in FIG. 3, the phone 302 responds to the PC 304's challenge over the SIP channel. The message, i.e., the response message, contains a device EPID, the challenge sent by the PC, and location identifying information. When the PC 304 receives the phone 302's response, the PC 204 uses the EPID, the challenge sent by the PC, and the location identifying information to verify that the appropriate response has been received from the SIP channel. If the location identifying information does not provide enough information to verify that the appropriate response has been received to automatically determine co-location, the user is prompted to confirm the location. If co-location is automatically determined or is verified by the user, the device, e.g., the phone 302, and the PC, e.g. PC 304, are paired and the phone can send messages specifically for the IP phone over a secure SIP channel. If the co-location is automatically selected, the automatic selection of is overrideable by the user.

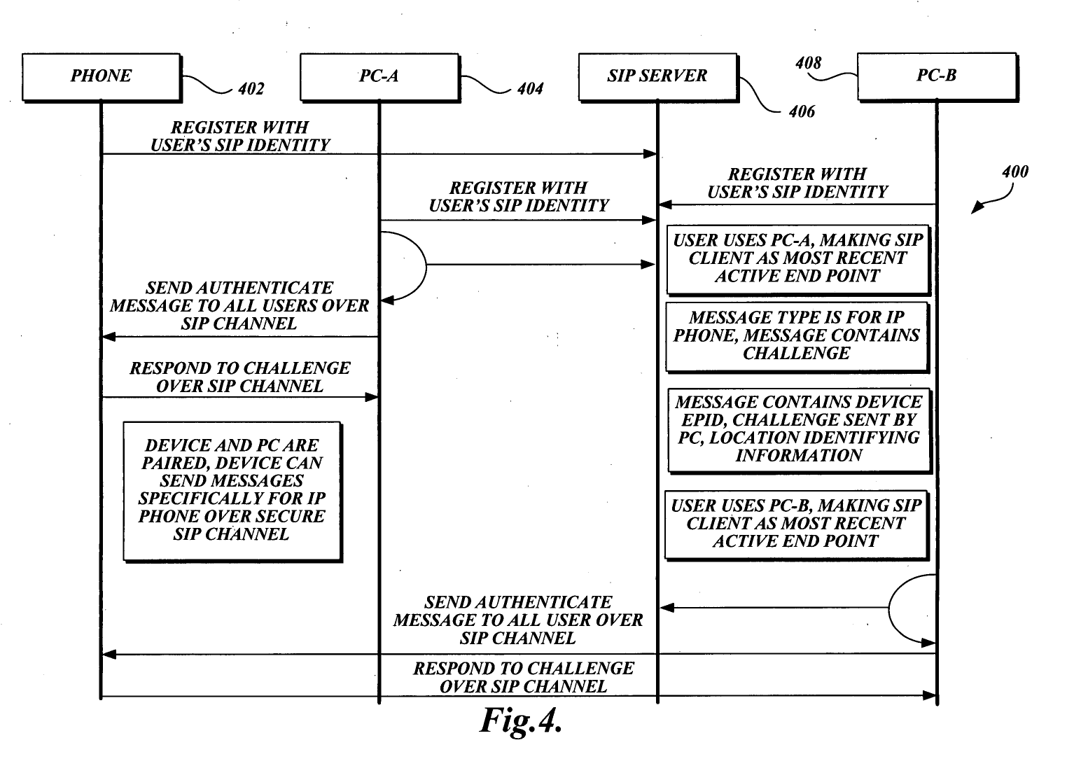

Similarly to the exemplary processes illustrated in FIGS. 2 and 3, the exemplary process illustrated in FIG. 4 is used to pair phones with PCs to provide secure VoIP communication on an IP network. The exemplary processes illustrated in FIGS. 2 and 3 involved one PC and one phone. The exemplary process illustrated in FIG. 4 is a pairing process involving one phone and multiple computing devices and using an IP channel for authentication. In the exemplary process 400 illustrated in FIG. 4, a phone 402, a first computing device, PC-A 404, a second computing device, PC-B 408, and an SIP server 406 interact. As noted above, preferably, the software components that enable the pairing reside on the PC-A 404, PC-B 408, and the phone 402. The exemplary process 400 begins at the top of FIG. 4 where the phone 402 registers with the SIP server 406 using the user's SIP identity. The PC-A 404 and the PC-B 408 also register with the SIP server 406 using the user's SIP identity. It is also possible for the PC-A 404 and the PC-B 408 to register with the SIP server 406 before the phone 402 registers with the SIP server 406 and for the PC-B 408 to register before the PC-A 404 or the phone 402.

At this point in exemplary process 400, the user uses PC-A 404, making SIP client PC-A 404 the most recent active end point. The PC-A 404 sends an authentication message to all users, i.e., all users connected to the IP network, over the SIP channel. Because the phone 402 is connected to the IP network, the phone 402 receives the authentication message. The phone 402 responds to the PC-A 404's challenge over the SIP channel. The message, i.e., the response message, contains a device EPID, the challenge sent by the PC (PC-A 404), and location identifying information. When the PC-A 404 receives the phone 402's response, the PC-A 404 uses the EPID, the challenge sent by the PC, and the location identifying information to verify that the appropriate response has been received from the SIP channel. The phone 402 determines that PC-A 404 is the most recent active end point. The device, e.g., the phone 402, and the PC, e.g. PC-A 404, are paired and the phone can send messages specifically for the IP phone over a secure SIP channel.

At this point in exemplary process 400, the user uses PC-B 408, making SIP client PC-B 408 the most recent active end point and replacing PC-A 404 as the most recent active end point. Similarly to PC-A 404, PC-B 408 sends an authentication message to all users, i.e., all users connected to the IP network, over the SIP channel. Because the phone 402 is connected to the IP network, the phone 402 receives the authentication message. The phone 402 responds to the PC-B 408's challenge over the SIP channel. Not shown in FIG. 4, the exemplary process 400 progresses in a fashion similar to the situation in which PC-A 404 was the most recent active end point. That is, the message, i.e., the response message, contains a device EPID, the challenge sent by the PC (PC-B 408), and location identifying information. When the PC-B 408 receives the phone 402's response, the PC-B 408 uses the EPID, the challenge sent by the PC, and the location identifying information to verify that the appropriate response has been received from the SIP channel. The phone 402 determines that PC-B 408 is the most recent active end point. The device, e.g., the phone 402, and the PC, e.g. PC-B 408, are paired and the phone can send messages specifically for the IP phone over a secure SIP channel.

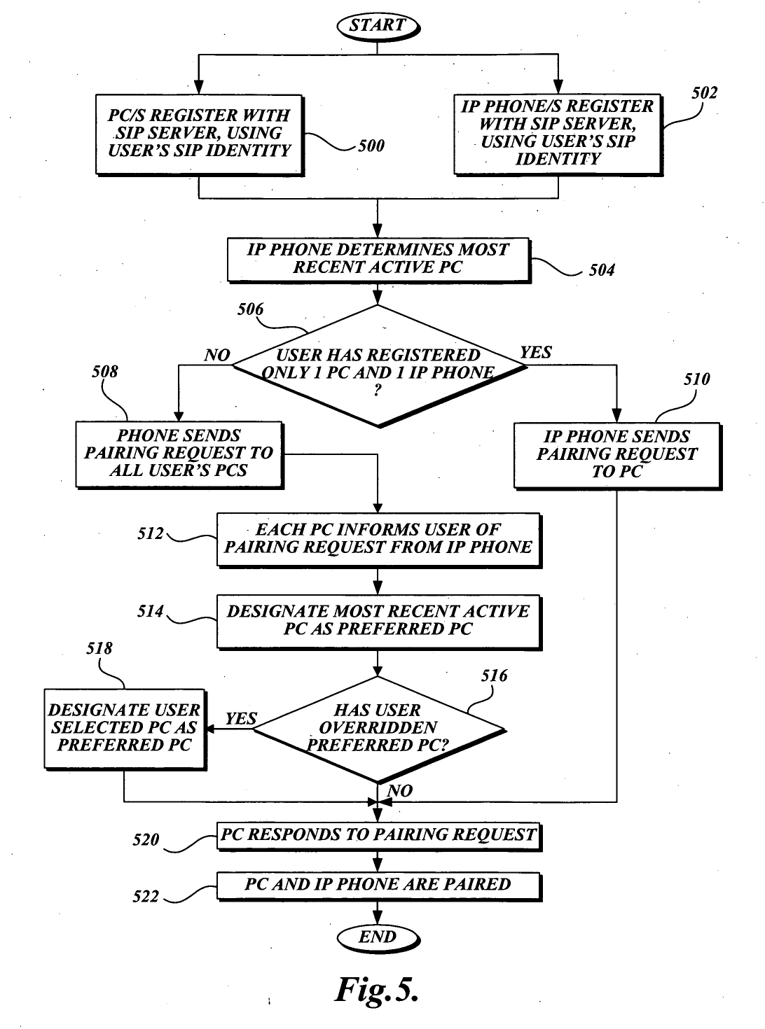

Exemplary processes of pairing phones with PCs, i.e., computing devices, are illustrated in FIGS. 2-4 and described above. Four exemplary methods for accomplishing phone to computing device and computing device to phone pairing are illustrated in FIGS. 5-8. As noted above, in pairing methods such as the exemplary pairing methods illustrated in FIGS. 5-8, preferably, the pairing software components reside on the computing devices and phones, and access SIP servers. Preferably, the pairing software components are not a part of the SIP servers.

FIG. 5 is a flow diagram illustrating an exemplary method for pairing an IP phone, which may be a member of a plurality of IP phones, with a computing device, which may be a member of a plurality of computing devices, using an IP channel for authentication to provide secure VoIP communication on an IP network. The method starts at block 500 in which a computing device, e.g., a PC, registers, such as machine A 100 shown in FIG. 1, (or PCs register) with an SIP server using the user's SIP identity. At block 502, an IP phone, such as IP phone 114 shown in FIG. 1, registers (or phones register) with an SIP server using the user's SIP identity. The action in block 500 may occur before the action in block 502 or vice versa or the actions in blocks 500 and 502 may occur simultaneously. At block 504, the phone determines the most recently active PC. At decision block 506, it is determined if the user has registered only one PC and one phone. If the user registered only one PC and only one phone, the control flows to block 510, where the phone sends a pairing request to the PC. The control then flows to block 520. If the user registered more than one PC and/or more than one phone, the control flows to block 508, where the phone sends pairing requests to all the user's registered PCs. At block 512, each PC informs the user of pairing requests from the phone. At block 514, the most recent active PC is designated as the preferred PC. At decision block 516, a test is made to determine if the user has overridden the preferred PC. Preferably, a timer is used to give the user a certain amount of time in which to decide whether or not to override the preferred PC and select a different preferred PC. If the user decides to select a new preferred PC, the control flows to block 518 where the user designates a selected PC as the preferred PC and the control flows to block 520. If the user decides not to select a new preferred PC, the control flows to block 520 where the preferred PC responds to the pairing request. At block 522, the preferred PC and the phone are paired. After block 522, the method ends.

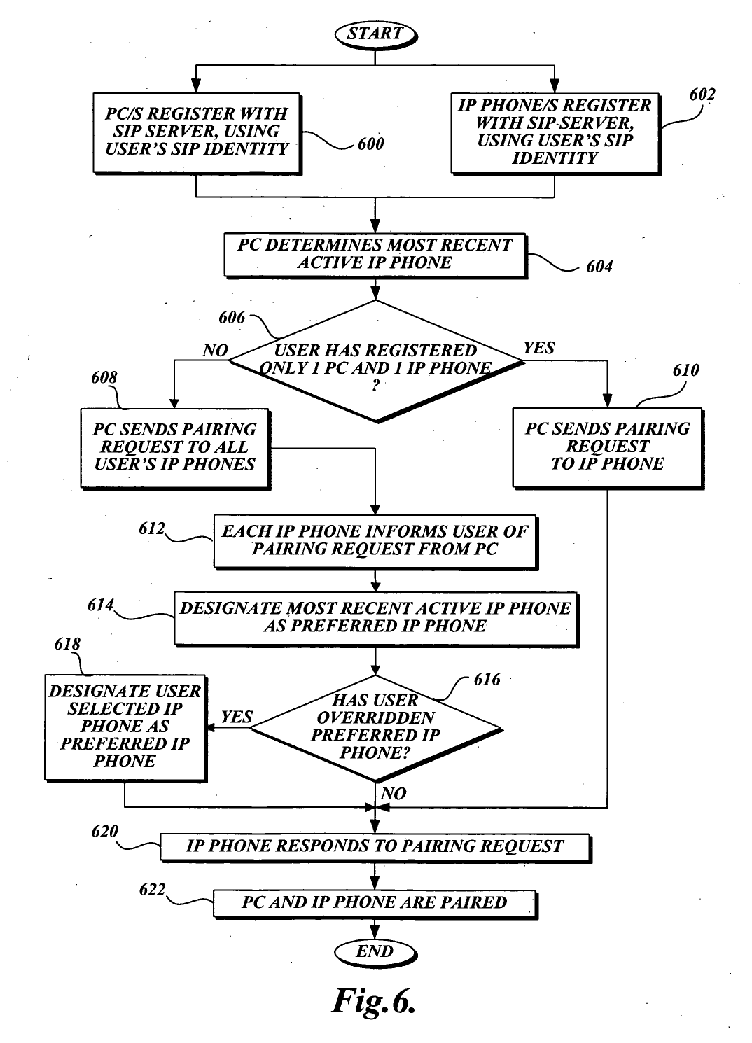

While the flow diagram shown in FIG. 5 illustrates an exemplary method for pairing an IP phone with a computing device using an IP channel for authentication to provide secure VoIP communication on an IP network, the flow diagram shown in FIG. 6 illustrates an exemplary method for pairing a computing device, which may be a member of a plurality of computing devices, with an IP phone, which may be a member of a plurality of IP phones, using an IP channel for authentication. The method illustrated in FIG. 6 begins at block 600, where one or more PCs register with the SIP server, using the server's SIP identity. At block 602, one or more IP phones register with the SIP server using the user's SIP identity. The action in block 600 may occur before the action in block 602 or vice versa or the actions in blocks 600 and 602 may occur simultaneously. At block 604, the PC determines the most recently active IP phone. At decision block 606, it is determined if the user has only one PC and only one phone. If the user has only one PC and only one phone, the control flows to block 610, where the PC sends a pairing request to the IP phone. The control then flows to block 620. Back at decision block 606, if the user has more than one PC or more than one phone, the control flows to block 608, where the PC sends a pairing request to an user's IP phones. At block 612, each IP phone informs the user of a pairing request from the PC. At block 614, the most recent active IP phone is designated as the preferred IP phone. At decision block 616, a test is made to determine if the user has overridden the preferred IP phone. Preferably, a timer is used to give the user a certain amount of time in which to decide whether or not to override the preferred IP phone and select a different preferred IP phone. If the user decides to select a new preferred IP phone, the control flows to block 618 where the user designates a selected IP phone as the preferred IP phone and the control flows to block 620. If the user decides not to select a new preferred IP phone, the control flows to block 620 where the preferred IP phone responds to the pairing request. At block 622, the preferred IP phone and the computing device are paired. After block 522, the method ends.

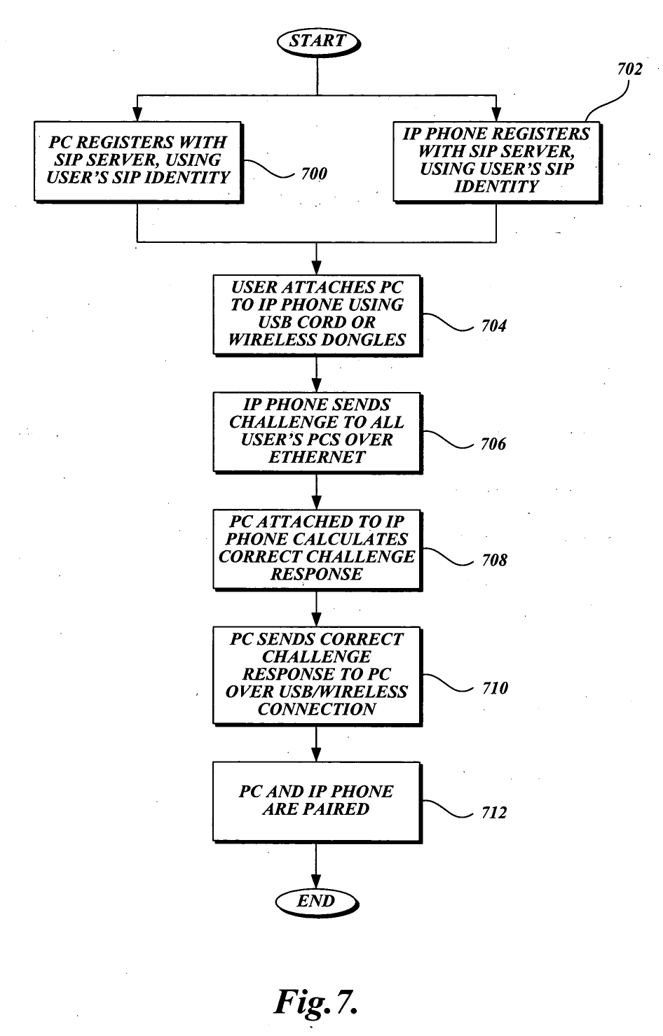

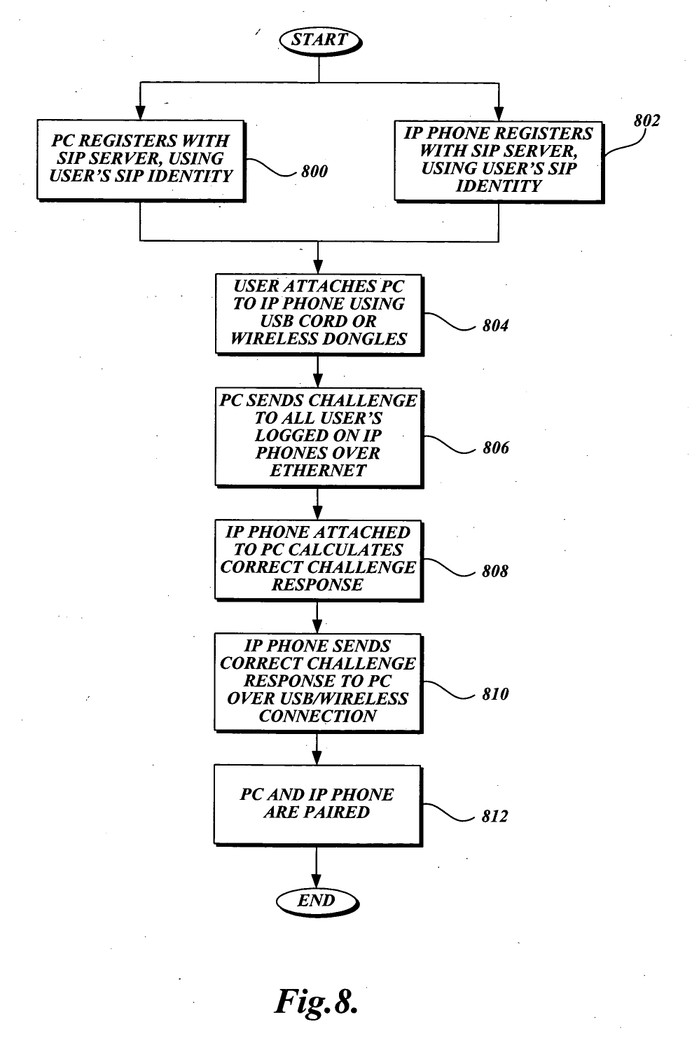

While FIGS. 5 and 6 illustrate exemplary methods for pairing IP phones with computing devices using an IP channel, FIGS. 7 and 8 illustrate exemplary methods for pairing IP phones with computing devices using a USB channel. The USB channel may be provided by connecting the computing devices and phones with USB cables or by attaching USB wireless “dongles” to the computing devices and phones. A dongle is a hardware device that can be attached to a device via a USB connector and that contains circuitry for wireless communication. It is also possible to use a combination of cabled and dongled computing devices and phones.

FIG. 7 is a flow diagram illustrating an exemplary method for pairing an IP phone with a computing device using more than one channel, i.e., an IP channel and a USB channel, for authentication,. The method starts at block 700, where a PC registers with the SIP server using the user's SIP identity. At block 702, an IP phone registers with an SIP server using the user's SIP identity. At block 704, a user attaches a PC to an IP phone using a USB cord or a wireless dongle. The actions in blocks 700, 702, and 704 may occur in any order and may occur simultaneously. At block 706, an IP phone sends a challenge to all the user's PCs over the Ethernet which is an exemplary IP network. At block 708, the PC attached to the IP phone calculates the correct challenge response. At block 710, the PC sends the correct challenge response to a PC over a USB or wireless network connection. At block 712, the PC and the phone are paired. After block 712, the method ends.

While the flow diagram shown in FIG. 7 illustrates an exemplary method for pairing an IP phone with a computing device using a USB channel for authentication, the flow diagram shown in FIG. 8 illustrates an exemplary method for pairing a computing device with an IP phone using more than one channel, i.e., an IP channel and a USB channel, for authentication, to provide secure VoIP communication on an IP network. As in the exemplary method illustrated in FIG. 7, the USB channel may be provided by connecting the computing devices and phones with USB cables or by attaching USB wireless dongles to the computing devices and phones or by a combination of cabled and dongled computing devices and phones. The method illustrated in FIG. 8 starts at block 800, where a PC registers with the SIP server using the user's SIP identity. At block 802, an IP phone registers with the SIP server using the user's SIP identity. At block 804, a user attaches a PC to an IP phone using a USB cord or a wireless dongle. At block 806, a PC challenges all the users logged on over IP phones over the Ethernet, which is an exemplary IP network. At block 808, an IP phone attached to a PC calculates the correct challenge response. At block 810, the IP phone sends a correct challenge response to the PC over the USB or wireless connection. At block 812, the PC and the phone are paired. After block 812, the method ends.

While illustrative embodiments have been illustrated and described, it will be appreciated that various changes can be made therein without departing from the spirit and scope of the invention. For example, the exemplary methods for pairing IP phones to computing devices to provide secure VoIP communication on an IP network that are illustrated in FIGS. 5-8 and described above may be applied to devices other than phones and computing devices. While an Ethernet network is presented in the above descriptions as an exemplary IP network, other IP networks may benefit from the illustrated and described embodiments.

The embodiments of the invention in which an exclusive property or privilege is claimed are defined as follows:

1. A method for securely pairing an IP phone with a computing device for secure VoIP communication on an IP network, the method comprising:
authenticating the IP phone to the computing device and the computing device to the IP phone using an identity registered with an identity service; and
if the authentication succeeds, creating a pairing data structure on the IP phone dedicated to communicating with the computing device and creating a pairing data structure on the computing device dedicated to communicating with the IP phone.

2. The method of claim 1, wherein authenticating the IP phone to the computing device and the computing device to the IP phone using an identity registered with the identity service comprises the IP phone:
(a) determining the most recent active computing device of a plurality of computing devices;
(b) transmitting the pairing request to each computing device of the plurality of computing devices;
(c) designating the most recent active computing device as a preferred computing device; and
(d) receiving a response from the preferred computing device.

3. The method of claim 2, wherein the designation of the preferred computing device is overrideable.

4. The method of claim 1, wherein authenticating the IP phone to the computing device and the computing device to the IP phone using an identity registered with the identity service comprises the computing device:
(a) determining the most recently active IP phone of a plurality of IP phones;
(b) transmitting a pairing request to each IP phone of the plurality of IP phones;
(c) designating the most recently active phone IP as a preferred IP phone; and
(d) receiving a response from the preferred phone.

5. The method of claim 4, wherein the designation of the preferred IP phone is overrideable.

6. The method of claim 1, wherein authenticating the IP phone to the computing device and the computing device to the IP phone using an identity registered with the identity service comprises:
(a) connecting the computing device and the IP phone via a network not connected to the IP network;
(b) the IP phone transmitting a challenge to each of a plurality of computing devices on the IP network; and
(c) the computing device connected to the IP phone via a network not connected to the IP network transmitting a correct response to the challenge.

7. The method of claim 6, wherein the network not connected to the IP network is a USB network.

8. The method of claim 6, wherein the network not connected to the IP network is a wireless network.

9. The method of claim 1, wherein authenticating the IP phone to the computing device and the computing device to the IP phone using an identity registered with the identity service comprises:
(a) connecting the computing device and the IP phone via a network not connected to the IP network;
(b) the computing device transmitting a challenge to each of a plurality of IP phones; and
(c) the IP phone connected to the computing device via a network not connected to the IP network transmitting a correct response to the challenge.

10. The method of claim 9, wherein the network not connected to the IP network is a USB network.

11. The method of claim 9, wherein the network not connected to the IP network is a wireless network.

12. A computer readable medium having stored thereon executable instructions that when selected pair a computing device to an IP phone, the computer executable instructions including:
an identification component for registering the computing device's identity with an identity service;
an identification component for accessing the identity service to acquire an IP phone's identity;
an authenticating component for authenticating the IP phone to the computing device using the IP phone identity acquired from the identity service; and
a pair data structuring component for creating a pairing data structure on the computing device dedicated to communicating with the IP phone.

13. The computer readable medium of claim 12, wherein the authenticating component for authenticating the IP phone to the computing device;
(a) determines the most recent active IP phone of a plurality of IP phones;
(b) transmits a pairing request to each IP phone of the plurality of IP phones; and
(c) designates the most recently active IP phone as a preferred IP phone.

14. The computer readable medium of claim 13, wherein the designation of the preferred IP phone is overrideable.

15. The computer readable medium of claim 12, wherein the authenticating component for authenticating the IP phone to the computing device authenticates the IP phone to the computing device uses more than one communication channel.

16. A computer readable medium having stored thereon executable instructions that when executed pair an IP phone to a computing device, the computer executable instructions including:
an identification component for registering the IP phone's identity with an identity service;
an identification component for accessing the identity service to acquire a computing device's identity;
an authenticating component for authenticating the computing device to the IP phone using the computing device's identity acquired from the identity service; and
a pair data structuring component for creating a pairing data structure on the IP phone dedicated to communicating with the computing device.

17. The computer readable medium of claim 16, wherein the authenticating component for authenticating the computing device to the IP phone:
(a) determines the most recently active computing device of a plurality of computing devices;
(b) transmits a pairing request to each computing device of the plurality of computing devices; and
(c) designates the most recently active computing device as a preferred computing device.

18. The computer readable medium of claim 17, wherein the designation of the preferred computing device is overrideable.

19. The computer readable medium of claim 16, wherein the authenticating component for authenticating the computing device to the IP phone authenticates the computing device to the IP phone uses more than one communication channel.

20. The computer readable medium of claim 19, wherein the more than one communication channels are an IP network and a USB network.
